(19) United States
(12) Patent Application Publication
(10) Pub. No.: US 2017/0082127 A1
(43) Pub. Date: Mar. 23, 2017

(54) SECURITY DISPLAY UNIT

(71) Applicant: Yi-Fu Chen, TAICHUNG CITY (TW)

(72) Inventor: Yi-Fu Chen, TAICHUNG CITY (TW)

(21) Appl. No.: 14/862,156

(22) Filed: Sep. 23, 2015

(51) Int. Cl. F16B 9/02

(52) U.S. Cl. CPC F16B 9/02

(57) ABSTRACT

A display unit includes a plate and a ring. The ring has a through hole with which a security member has the first end thereof is engaged. The second end of the security member extends beyond the through hole. The security member is pivotable relative to the through hole. An insertion hole is defined in the second end of the security member so as to receive a hand tool therein. One of sidewalls of the insertion hole has an opening. A restriction member is connected to the security member and has an engaging portion which extends through the opening and located in the insertion hole. The engaging portion is inserted into a gap between a bead and a reception hole for receiving the bead of the handle tool. The engaging portion is deeply inserted into the gap when the hand tool is pulled away from the ring.

### BACKGROUND OF THE INVENTION

1. Fields of the invention

The present invention relates to a security display unit, and more particularly, to a security display unit for securing a hand tool thereto and the hand tool cannot be stolen without proper processes.

2. Descriptions of Related Art

The conventional display unit generally includes a first plate for being hanged on a display board or a wall. The first plate has a first connection portion. A second plate has a second connection portion which is connected to the first connection. The first plate further has a rotary portion. A cover is connected to the second connection portion so as to form a room therebetween. The hand tool is inserted into the room and connected to the rotary portion such that the customers can rotate the handle extending from the display unit to try to operate the ratchet means of the hand tool. The conventional display unit is complicated and required a lot of time to assemble.

FIGS. 11 and 12 show another display unit which includes a plate 5 with a hanging hole, and a ring 6 is connected to a lower end of the plate 5. An insertion hole 61 is defined through the ring 6 and has two grooves 62 located on two lower corners of the insertion hole 61. A security member 7 is slid into the two grooves 62 by its two sides, and the security member 7 has a resilient tongue 71 which is to be inserted into the gap between the bead and the reception hole for receiving the bead of an engaging block of a hand tool. The tongue 71 prevents the hand tool from being pulled out from the insertion hole because the pulling direction is opposite to the direction that the tongue extends.

The security member 7 has to be a wide and rectangular plate such that the two sides of the security member 7 can be slid into the grooves 62. However, when assembling the display unit, the front two corners have to be cut in order to be inserted into the grooves 62. Besides, the insertion and removal of the security member 7 require a significant force.

The present invention intends to provide a display unit to eliminate the shortcomings mentioned above.

### SUMMARY OF THE INVENTION

The present invention relates to a display unit comprises a through hole defined therethrough. A security member has the first end thereof engaged with the through hole, and the second end of the security member extends beyond the through hole. The security member is pivotable relative to the through hole. An insertion hole is defined in the second end of the security member, and an opening is defined through one of sidewalls of the insertion hole. A restriction member is connected to the first end of the security member and has an engaging portion which extends through the opening and is located in the insertion hole. The engaging portion is to be inserted into the gap between the bead and the reception hole for receiving the bead of the handle tool.

Preferably, the insertion hole has a flange extending radially and inward from the inner periphery thereof, and multiple teeth are formed along the inner periphery of the flange. Two first extensions and two second extensions extend from the second end of the security member. The two first extensions and two second extensions are located alternatively to each other, and a gap is formed axially between the two first extensions and two second extensions so as to clamp the flange between the two first extensions and two second extensions.

Preferably, a slot is defined axially through the security member so as to form a first part and a second part. At least one bridge is connected between the first part and the second part. The first part and the second part are to clamp the hand tool.

Preferably, the restriction member is formed by bending a wire into a U-shaped restriction member. The engaging portion extends from one of two ends of the restriction member.

Preferably, another opening is defined through another one of sidewalls of the insertion hole. The two openings are located at two facing sidewalls. The other one of the two ends of the restriction member has another engaging portion. The two engaging portions respectively extend through the two openings.

Preferably, the restriction member is formed by bending a wire into an L-shaped restriction member. The engaging portion extends from one of two ends of the restriction member.

Preferably, the security member has two rails extending from one side thereof so as to define two grooves between the rails and the two sides of the security member. The restriction member is a plate which has two sides inserted into the two grooves. The engaging portion of the restriction member extends through the opening and is located in the insertion hole.

Preferably, the display unit has a plate and a ring which is connected to the plate. The through hole is defined through the ring.

Preferably, the security member has a slit defined in the outside thereof and the slit is located corresponding to the restriction member. The restriction member is engaged with the slit and in flush with the outside of the security member.

The primary object of the present invention is to provide a display unit wherein the engaging portion of the restriction member is inserted into the gap between the bead and the reception hole for receiving the bead of the handle tool, so that when the hand tool is pulled away from the display unit, the pulling direction deeply pushes the engaging portion into the gap to prevent the hand tool from being separated from the display unit.

Another object of the present invention is to provide a display unit wherein the position of the restriction member relative to the display unit allows the assemblers to easily assemble the display unit regardless of the sizes of the assemblers' fingers.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the display unit of the present invention;

FIG. 2 is an exploded view of the display unit of the present invention;

FIG. 3 is a perspective view to show the security member of the display unit of the present invention;

FIG. 4 shows that a hand tool is connected to the display unit of the present invention;

FIG. 5 is a cross sectional view to show that the engaging portion of the restriction member is inserted into the gap between the bead and the reception hole for receiving the bead of the handle tool;

FIG. 6 is a cross sectional view to show that when the hand tool is pulled away from the display unit, the engaging portion of the restriction member is further deeply inserted into the gap between the bead and the reception hole for receiving the bead of the handle tool;

FIG. 7 is an exploded view of the second embodiment of the display unit of the present invention;

FIG. 8 is an exploded view of the third embodiment of the display unit of the present invention;

FIG. 8-1 shows that there are two openings in the insertion hole of the security member and the two engaging portions extend through the two openings;

FIG. 9 is a perspective view to show the fourth embodiment of the display unit of the present invention;

FIG. 10 is an exploded view of the fourth embodiment of the display unit of the present invention;

FIG. 11 is an exploded view to show the conventional security member and the conventional display unit, and

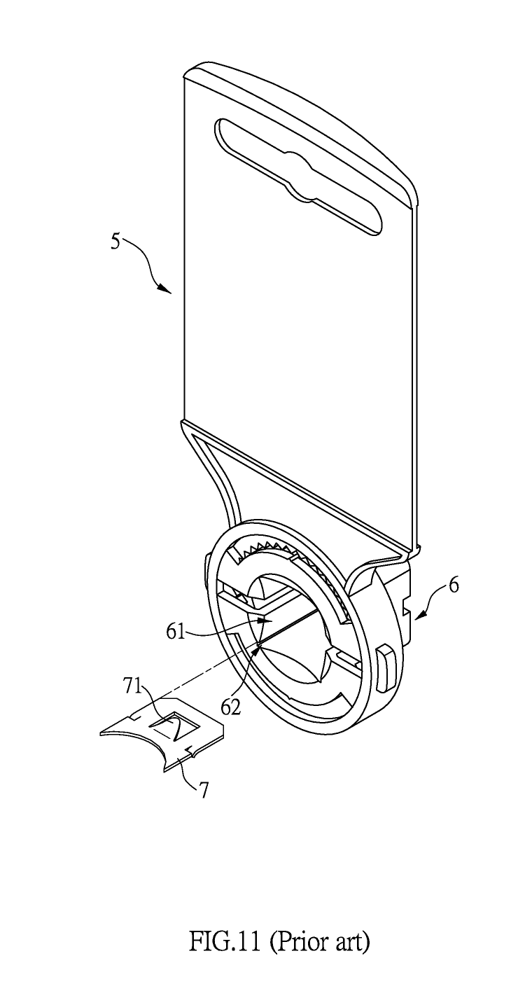

FIG. 12 is an exploded view to show the head of a hand tool and the conventional display unit.

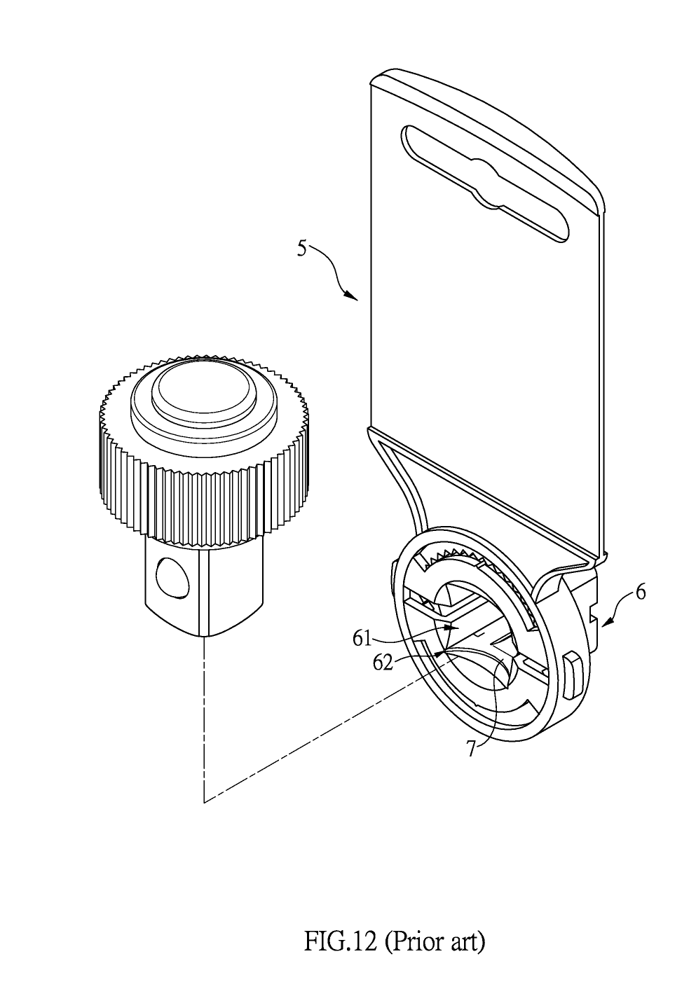

### DETAILED DESCRIPTION OF THE PREFERRED EMBODIMENT

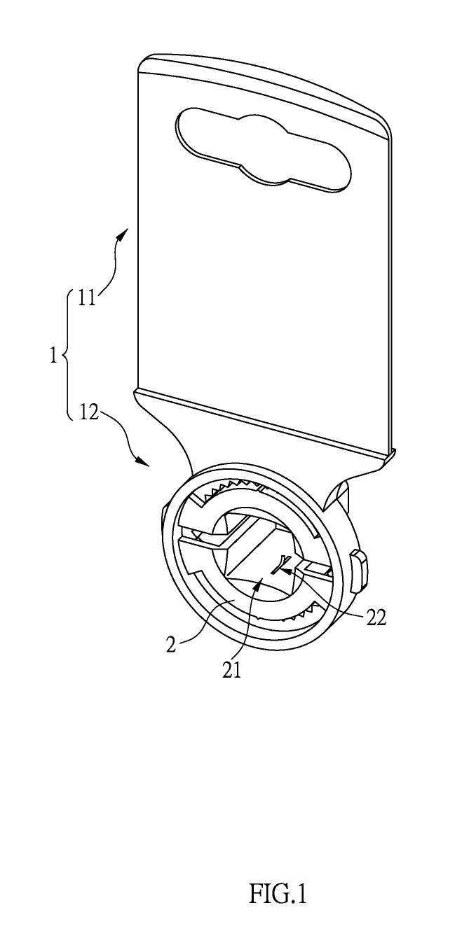

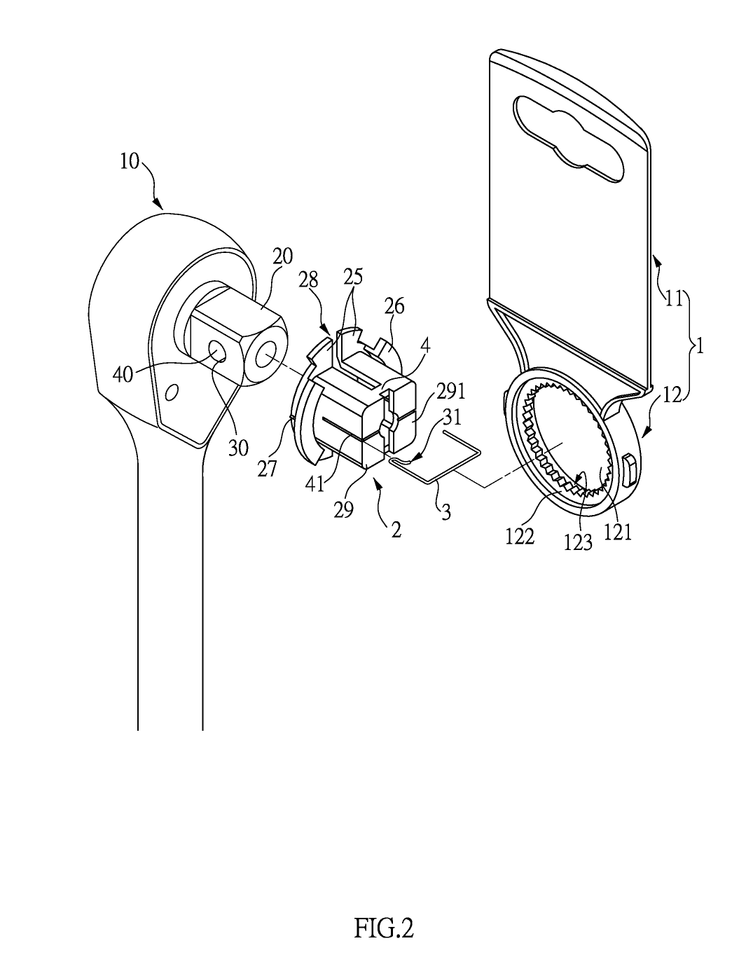

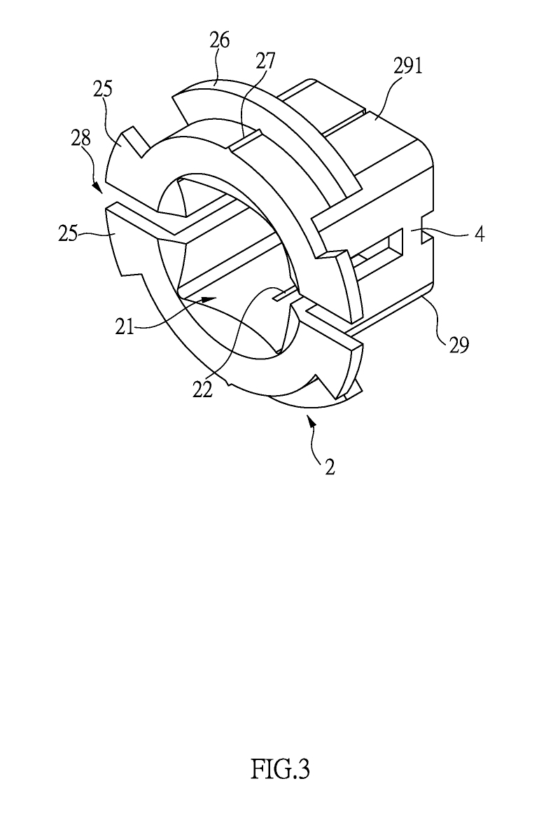

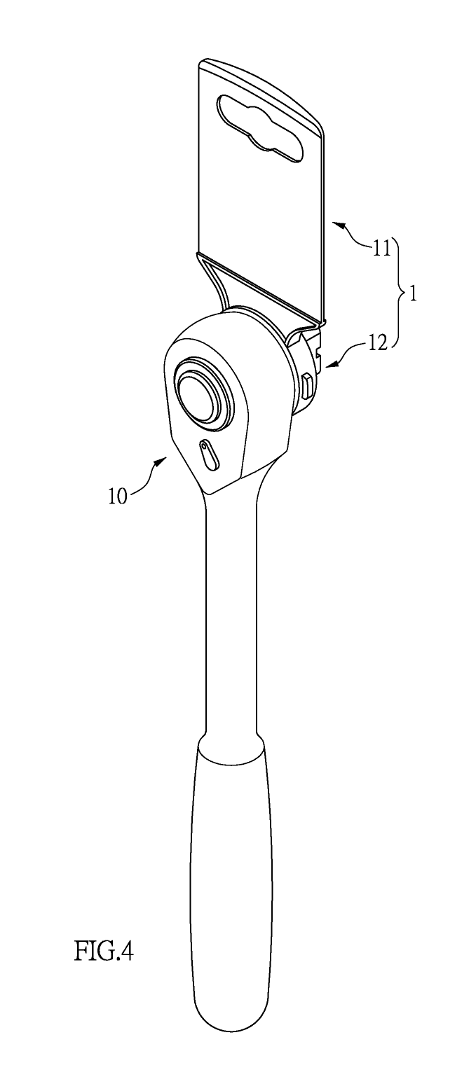

Referring to FIGS. 1 to 6, the display unit 1 of the present invention comprises a plate 11 and a ring 12 which is connected to the plate 11. The plate 11 has a hanging hole and the ring 12 has a through hole 121 defined therethrough. The insertion hole 21 has a flange 122 extending radially and inward from the inner periphery thereof Multiple teeth 123 are formed along the inner periphery of the flange 122. A security member 2 has the first end thereof engaged with the through hole 121, and the second end of the security member 2 extends beyond the through hole 121. Two first extensions 25 and two second extensions 26 extend from the second end of the security member 2. The two first extensions 25 and two second extensions 26 are located alternatively to each other. A gap is formed axially between the two first extensions 25 and two second extensions 26. The flange 122 is clamped between the two first extensions 25 and two second extensions 26. A ridge 27 extends from the outer periphery of the second end of the security member 2 and located between the two first extensions 25 and two second extensions 26. The ridge 27 is removably engaged with the teeth 123 of the flange 122. An insertion hole 21 defined in the second end of the security member 2, and an opening 22 is defined through one of sidewalls of the insertion hole 21. The engaging block 20 of the hand tool 10 is inserted into the through hole 121 of the security member 2. The security member 2 is pivotable relative to the through hole 121, such that the consumers may try to rotate the hand tool 10, the security member 2 together with the engaging block 20 is rotated, and the ridge 27 moves over the teeth 123 of the flange 122. A slot 28 is defined axially through the security member 2 so as to form a first part 29 and a second part 291. At least one bridge 4 is connected between the first part 29 and the second part 291. The first part 29 and the second part 291 can resiliently clamp the engaging block 20 of the hand tool 10. The security member 2 further has a slit 41 defined in the outside thereof as shown in FIG. 2.

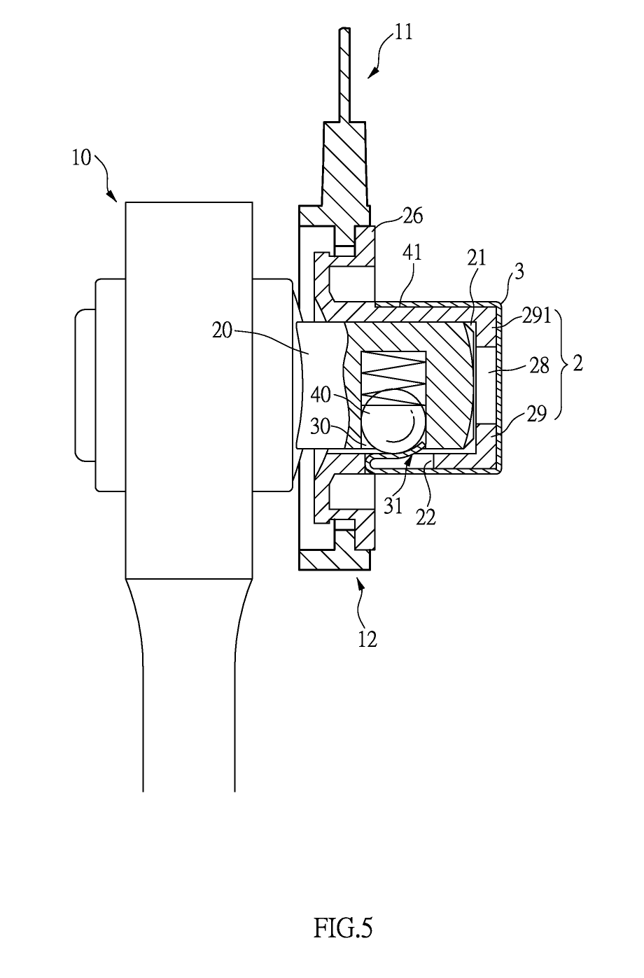

A restriction member 3 is connected to the first end of the security member 2. Specifically, the restriction member 3 is engaged with the slit 41 and in flush with an outside of the security member 2. The restriction member 3 is formed by bending a wire into a U-shaped restriction member 3. An engaging portion 31 extends from one of two ends of the restriction member 3. The engaging portion 31 extends through the opening 22 and located in the insertion hole 21. The engaging portion 31 is inserted into a gap between the bead 40 and the reception hole 30 for receiving the bead 40 of the engaging block 20 of the handle tool 10 as shown in FIG. 5.

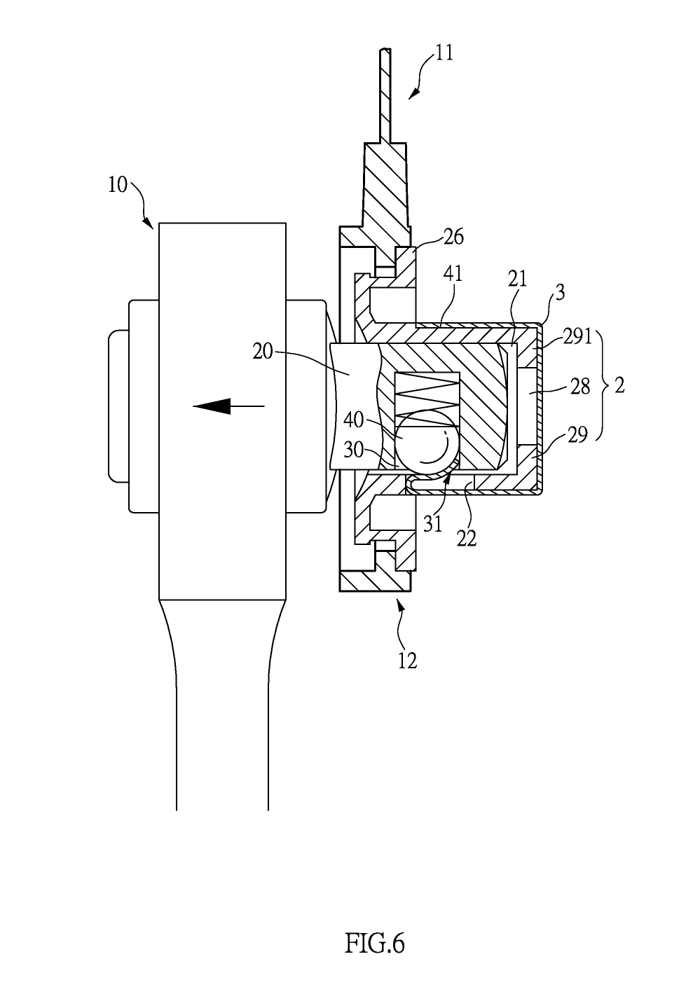

As shown in FIG. 6, when a person tries to pull the hand tool 10 out from the display unit 1 without permission, the pulling direction makes the engaging portion 31 to be further deeply inserted into the gap between the bead 40 and the reception hole 30 for receiving the bead 40. Therefore, the hand tool 10 is prevented from being stolen by pulling it away from the display unit 1. Furthermore, the position of the restriction member 3 relative to the display unit 1 allows the assemblers to easily assemble the display unit 1 regardless of the sizes of the assemblers' fingers.

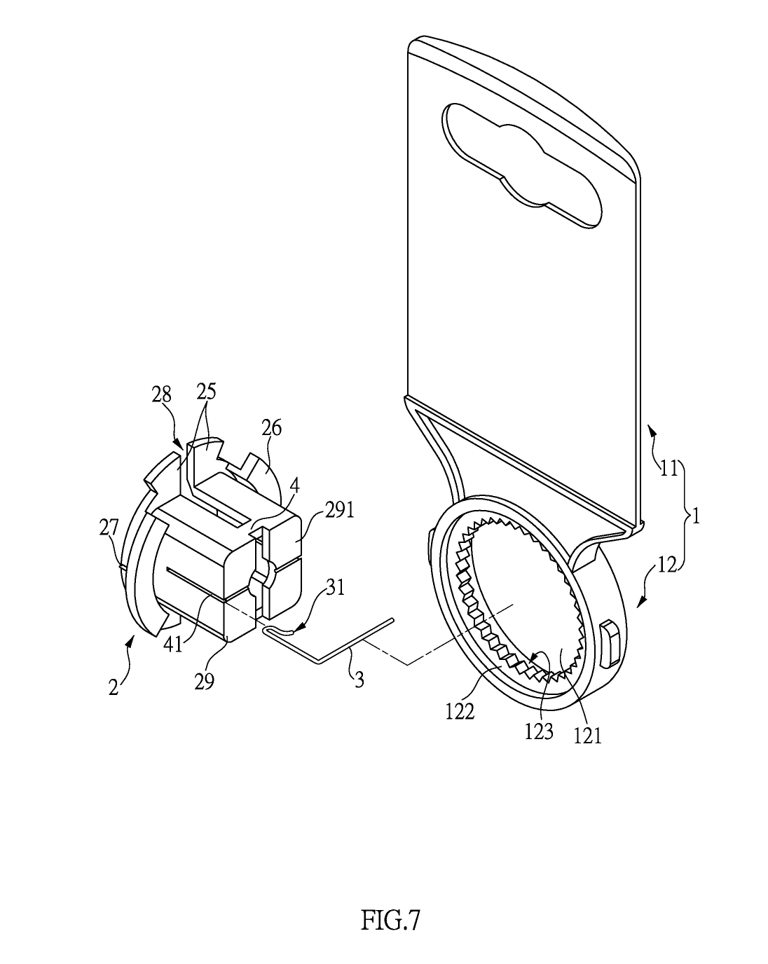

FIG. 7 shows the second embodiment of the display unit 1, wherein the restriction member 3 is formed by bending a wire into an L-shaped restriction member 3, and the engaging portion 31 extends from one of two ends of the restriction member 3. The restriction member 3 is engaged with the slit 41 and the engaging portion 31 extends through the opening 22 and is inserted into the gap between the bead 40 and the reception hole 30 for receiving the bead 40 of the engaging block 20 of the handle tool 10.

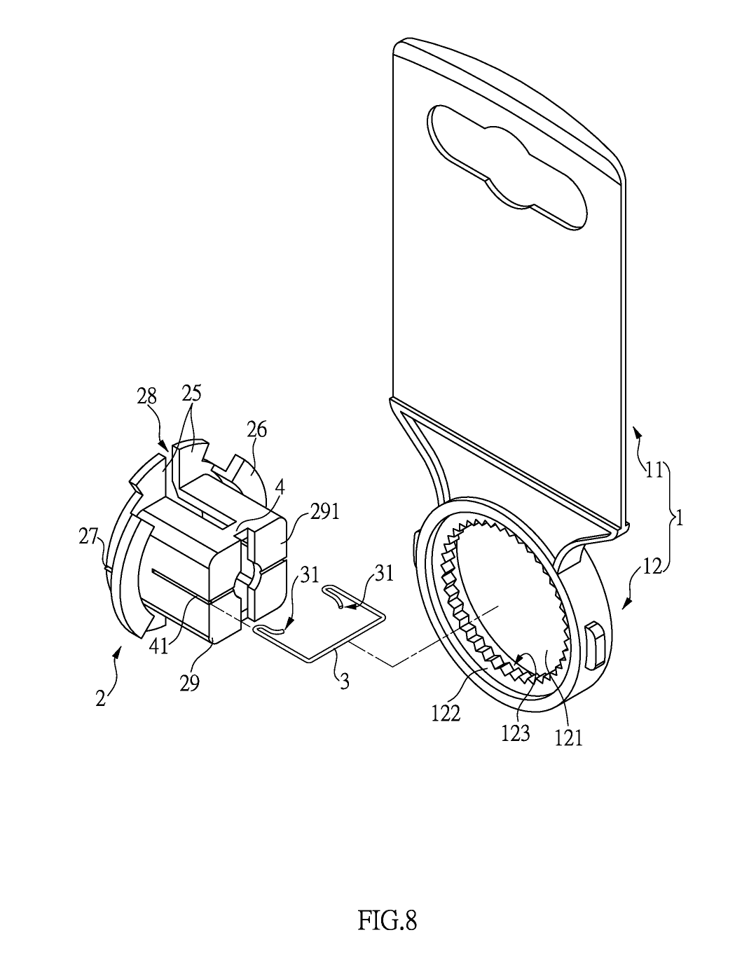

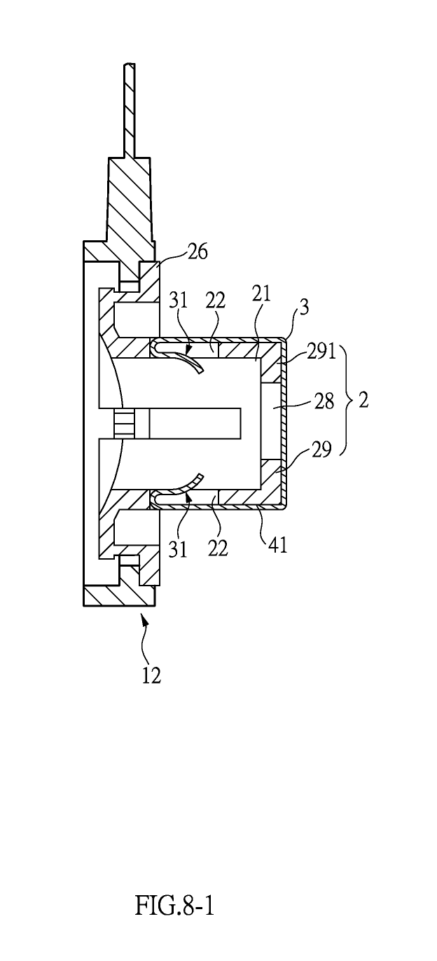

FIGS. 8 and 8-1 show the third embodiment of the display unit 1, wherein another opening is defined through another one of sidewalls of the insertion hole 21. The two openings are located at two facing sidewalls. The other one of the two ends of the U-shaped restriction member 3 has another engaging portion 31. The two engaging portions 31 respectively extend through the two openings 22.

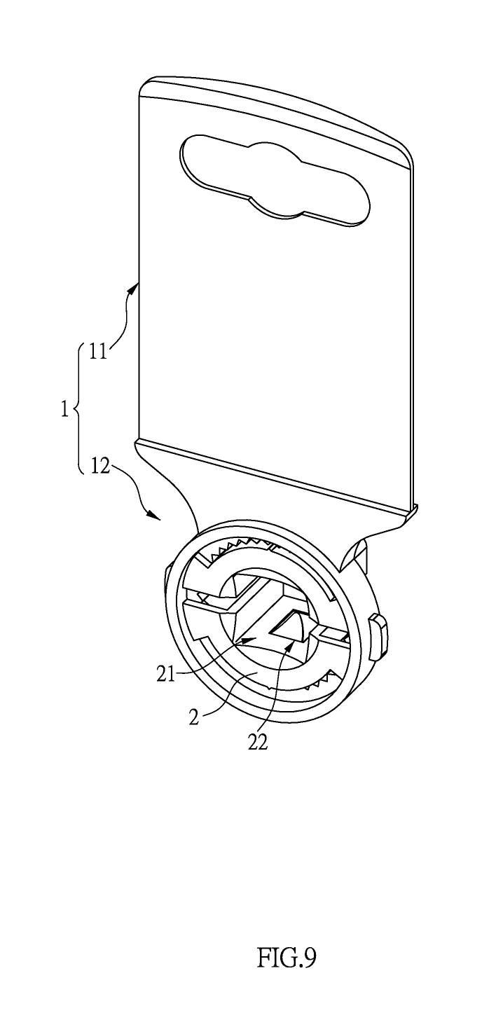

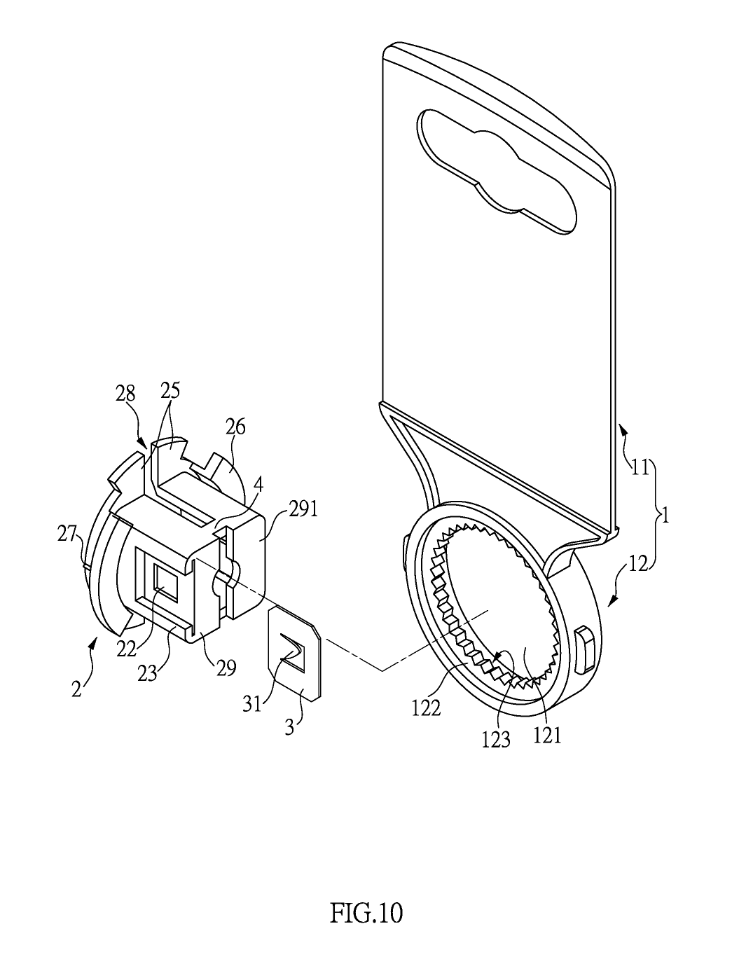

FIGS. 9 and 10 show the fourth embodiment of the display unit 1, wherein the security member 2 has two rails 23 extending from one side thereof so as to define two grooves 24 between the rails 23 and the two sides of the security member 2. The restriction member 3 is a plate which has two sides inserted into the two grooves 24. The engaging portion 31 of the restriction member 3 extends from a central portion of the restriction member 3. The engaging portion 31 extends through the opening 22 and is located in the insertion hole 21.

The pulling direction makes the engaging portion 31 to be further deeply inserted into the gap between the bead 40 and the reception hole 30 for receiving the bead 40. Therefore, the display unit 1 of the present invention provides a safety feature to protect the hand tool 10 from being stolen by pulling it away from the display unit 1.

While we have shown and described the embodiment in accordance with the present invention, it should be clear to those skilled in the art that further embodiments may be made without departing from the scope of the present invention.

What is claimed is:

1. A display unit for being connected to a hand tool, comprising:
a through hole defined therethrough;
a security member having a first end engaged with the through hole, a second end of the security member extending beyond the through hole, the security member being pivotable relative to the through hole, an insertion hole defined in the second end of the security member, an opening defined through one of sidewalls of the insertion hole, and
a restriction member connected to the first end of the security member and having an engaging portion which extends through the opening and located in the insertion hole, the engaging portion adapted to be inserted into a gap between a bead and a reception hole for receiving the bead of the handle tool.

2. The display unit as claimed in claim 1, wherein the insertion hole has a flange extending radially and inward from an inner periphery thereof, multiple teeth are formed along an inner periphery of the flange, two first extensions and two second extensions extend from the second end of the security member, the two first extensions and two second extensions are located alternatively to each other, a gap is formed axially between the two first extensions and two second extensions, the flange is clamped between the two first extensions and two second extensions.

3. The display unit as claimed in claim 1, wherein a slot is defined axially through the security member so as to form a first part and a second part, at least one bridge is connected between the first part and the second part, the first part and the second part are adapted to clamp the hand tool.

4. The display unit as claimed in claim 2, wherein a slot is defined axially through the security member so as to form a first part and a second part, at least one bridge is connected between the first part and the second part, the first part and the second part are adapted to clamp the hand tool.

5. The display unit as claimed in claim 1, wherein the restriction member is formed by bending a wire into a U-shaped restriction member, the engaging portion extends from one of two ends of the restriction member.

6. The display unit as claimed in claim 5, wherein another opening is defined through another one of sidewalls of the insertion hole, the two openings are located at two facing sidewalls, the other one of the two ends of the restriction member has another engaging portion, the two engaging portions respectively extend through the two openings.

7. The display unit as claimed in claim 1, wherein the restriction member is formed by bending a wire into an L-shaped restriction member, the engaging portion extends from one of two ends of the restriction member.

8. The display unit as claimed in claim 1, wherein the security member has two rails extending from one side thereof so as to define two grooves between the rails and the two sides of the security member, the restriction member is a plate which has two sides inserted into the two grooves, the engaging portion of the restriction member extends through the opening and located in the insertion hole.

9. The display unit as claimed in claim 1 further comprising a plate and a ring which is connected to the plate, the through hole is defined through the ring.

10. The display unit as claimed in claim 1, wherein the security member has a slit defined in an outside thereof and the slit is located corresponding to the restriction member, the restriction member is engaged with the slit and in flush with an outside of the security member.
